(19) United States
(12) Patent Application Publication
(10) Pub. No.: US 2007/0252910 A1
(43) Pub. Date: Nov. 1, 2007

(54) Image recording system

(76) Inventors: Frank Gottwald, Weissach (DE); Jens Schick, Herrenberg (DE); Volker Luhr, Ludwigsburg (DE)

Correspondence Address: KENYON & KENYON LLP, ONE BROADWAY, NEW YORK, NY, 10004, US

(21) Appl. No.: 11/704,513

(22) Filed: Feb. 9, 2007

Related U.S. Application Data
(63) Continuation of application No. 10/567,533, now abandoned.

(30) Foreign Application Priority Data
Aug. 6, 2003 (DE) 103 35 906.0
May 6, 2003 (DE) 10 2004 022 271.1

(51) Int. Cl. H04N 5/00

(52) U.S. Cl. 348/373

(57) ABSTRACT

An image recording system, particularly for use in a motor vehicle, and a method for producing an image recording system are provided. The image recording system includes an image sensor, an optical unit, a housing and fastening arrangement for fixing the image sensor in position relative to the housing, permit axial alignment of the main axis of the image sensor and the main axis of the optical unit relative to each other.

### CROSS-REFERENCE TO RELATED APPLICATIONS

This application is a continuation of prior application U.S. Ser. No. 10/567,533 filed Feb. 6, 2006, which was a National Stage Application of PCT International Application of PCT/DE2004/001627 filed Jul. 22, 2004, which claimed priority to German Patent Application No DE 103 35 906.0 filed Aug. 6, 2003, all of which are incorporated herein by reference in their entirety.

### FIELD OF THE INVENTION

The present invention relates to an image recording system and a method for producing an image recording system.

### BACKGROUND INFORMATION

German Published Patent Application No. 199 17 438 describes a circuit configuration and a method for producing a circuit configuration, the circuit configuration including a printed circuit board and an image recorder disposed thereon. A lens holder for accommodating and securing optical elements is also described. German Published Patent Application No. 199 17 438 contains no references to an image recording system having a simple design, accompanied at the same time by high accuracy of the image recording system.

### SUMMARY OF THE INVENTION

The image recording system described below, especially for use in a motor vehicle, made up of at least one image sensor, at least one optical unit, at least one housing and fastening means for fixing the image sensor in position relative to the housing—the housing having means for accommodating the optical unit, the housing having alignment means on the inside that permit an alignment, especially an attachment-free axial alignment, of the main axis of the image sensor and the main axis of the optical unit relative to each other—has the advantage that a simple design is achieved, accompanied at the same time by high accuracy of the image recording system.

The housing means for accommodating the optical unit is advantageously a threaded mount. A threaded mount offers many advantages. First of all, it is possible to mount the optical unit by screwing it into the housing in simple and positionally-accurate fashion. Moreover, the threaded mount offers the possibility of adjusting the image sharpness of the image sensor in a simple manner by screwing the optical unit in or out.

It is particularly advantageous that the image sensor is arranged on a printed circuit board, since this permits short signal paths and energy-supply paths to downstream electronics units. This advantageously contributes to a compact design of the image recording system. It is also advantageous if, in this context, the printed circuit board is able to be positioned relative to the housing by second alignment means, particularly at least with the aid of at least one spacer. High mechanical stability and high vibrational tolerance of the image recording system are thereby attained, which, because of this, is particularly suitable for use in automotive engineering, thus, for installation in a motor vehicle.

The use of a tension spring as fastening means for fixing the image sensor in position relative to the housing is advantageous, since tension springs as a releasable connection permit a simple mounting.

It is particularly advantageous that at least one part of the alignment means is adjustable, since it is thereby possible to compensate for tolerances in the production of the image sensor and/or the housing. In this connection, at least three spacers as first alignment means have proven to be advantageous for setting the image sensor apart from the housing, preferably at least two of the at least three spacers being adjustable in the spacing direction.

The method described in the following for producing an image recording system, in particular an image recording system in which an attachment-free, axial alignment of the main axis of an image sensor of the image recording system and the main axis of an optical unit of the image recording system relative to each other is implemented by alignment means mounted on the inner side of a housing of the image recording system, the main axis of the image sensor and the main axis of the optical unit are radially aligned relative to each other as a function of image data of the image sensor in such a way that the image sensor generates the image data from a test pattern located outside of the housing—has the advantage that high accuracy is achieved by the feedback mounting of the image sensor, i.e., the printed circuit board having the image sensor, relative to the optical unit or the housing. It is also advantageous that the image sharpness is set as a function of the image data from the test pattern by adjusting the position of the optical unit in the housing of the image recording system using an adjusting mechanism, since in so doing, both the alignment of the image sensor with respect to the optical unit and the image sharpness are set in one manufacturing process.

It is especially advantageous that, as a function of the image data from the test pattern, at least one adjustment parameter of the image sensor, e.g., at least one adjustment parameter for the intrinsic calibration and/or at least one adjustment parameter of the fixed pattern noise correction is/are ascertained and optionally set, since in so doing, still another adjustment process is carried out in integrated fashion during the production of the image recording system. This advantageously leads to a reduction in manufacturing costs for the image recording system, which at the same time exhibits high accuracy.

The above-indicated advantages for the image recording system also hold true for a method for producing an image recording system according to the present invention.

### BRIEF DESCRIPTION OF THE DRAWINGS

FIG. 1 shows an image recording system of the preferred exemplary embodiment.

FIG. 2 shows a variant of the image recording system of the preferred exemplary embodiment.

FIG. 3 shows a flow chart of the method of the preferred exemplary embodiment.

FIG. 4 shows a further variant of the image recording system in a sectional view.

FIG. 5 shows another variant of the image recording system in a sectional view.

### DETAILED DESCRIPTION

In the following, an image recording system, particularly for use in a motor vehicle, and a method for producing an image recording system are described.

The image recording system includes an image sensor, an optical unit, a housing and fastening means for fixing the image sensor in position relative to the housing, the housing having alignment means on the inner side that permit an alignment, particularly an attachment-free, axial alignment, of the main axis of the image sensor and the main axis of the optical unit relative to each other.

Image recording systems provided for automotive use must, on one hand, be very rugged, but all at once must also be very accurate. At the same time, another criterion is that the image recording systems be inexpensive. High accuracy of image recording systems may be attained, for example, by an additional degree of complexity in the design, pins stop edges having highly precise dimensional accuracy representing the significant solution possibilities. The solution possibilities described are generally associated with increased costs. These costs are necessary for the assembly process, but not for the use of the image recording system.

In principle, feedback systems also make it possible to achieve the required accuracy. For example, it is conceivable to incorporate external sensors, e.g., position-reference sensors, into the production line when manufacturing the image recording system, which measure the image recording systems during production and intervene in controlling fashion in response to deviations. For instance, it is conceivable for these external sensors to monitor features on the object to be produced which in the design, have a dimensionally true connection with the precision used, in that, for example, an imprinted circle is monitored that stands dimensionally true with respect to a sensor utilized later, particularly an image sensor. In this context, the useful signal is thus not evaluated, but rather a feature via an external sensor which, on its part, is produced in an imprecisely known dimensional accuracy with respect to the actual useful sensor.

In the following, an image recording system and a method for producing an image recording system are described which make it possible to accomplish the feedback with the actual image sensor, no additional features on the object, thus, the image sensor, being necessary for production. Consequently, the manufacturing precision corresponds nearly exactly to the use precision of the image sensor. A prerequisite for this is that the image recording system with the image sensor be at least partially functional in this production step. To that end, the image recording system is designed in such a way that it is possible to shift the printed circuit board together with the image sensor and subsequently secure it in the shifted state.

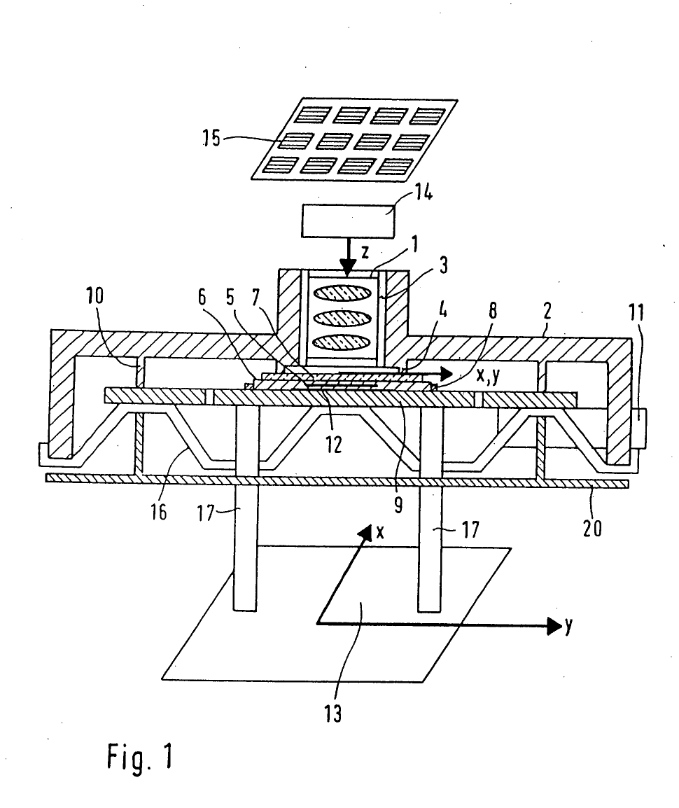

FIG. 1 shows an image recording system of the preferred exemplary embodiment, made up of a housing 2, an optical unit 1, an image sensor 12 (imager chip), spacers 4 and a tension spring 16. The image recording system is made up of an optical unit 1 and an imager 5 that is positioned with dimensional accuracy relative to this optical unit 1. In the preferred exemplary embodiment, optical unit 1 is designed as a cylinder screwed directly into housing 2 into a threaded cylindrical hole 3. In the preferred exemplary embodiment, three spacers 4 are mounted on the inside of housing 2 around cylindrical hole 3 having optical unit 1. Three spacers 4 are a minimum number for establishing a plane. The plane thus established is nearly perpendicular to the axis of cylindrical hole 3, and therefore perpendicular to the main axis of optical unit 1 located in cylindrical hole 3. This plane permits the axial alignment of the main axis of image sensor 12 and the main axis of optical unit 1 relative to each other. The main axis of image sensor 12 is the vertical onto the light-sensitive plane of image sensor 12 through the image center. The dimensional accuracy between the plane, defined by spacers 4, and the axis of cylindrical hole 3 is achievable, for example, by computer-aided manufacturing methods, e.g., by material processing on CNC milling machines. The axis of cylindrical hole 3 corresponds within given tolerances to the later optical axis of the image recording system, the direction of the optical axis of the image recording system being established through two points, the nodal point of the lens and the midpoint of image sensor 12. Image sensor 12 (imager chip) is positioned at the planes defined by spacers 4. Image sensor 12 contains imager 5, thus, the photosensitive part of image sensor 12, in housing 6 of image sensor 12, as well as a transparent protective cover 7 that is mounted in plane-parallel fashion with respect to imager 5. The dimensional accuracy of imager 5 in relation to protective cover 7 is accomplished with high quality in the chip production. On the other hand, the dimensional accuracy of electrical connections 8 on the bottom side of image sensor 12 and the position of image sensor 12 on printed circuit board 9 play no role for the necessary precision. Further spacers 10 are mounted at a greater distance to cylindrical hole 3 in relation to the dimensions of image sensor 12, these spacers 10 being produced and mounted with less precision compared to spacers 4 in the area of cylindrical hole 3. Located on printed circuit board 9 are the functional electronics and a socket 11 for the transmission of data, e.g., image data, and energy, so that printed circuit board 9 together with image sensor 12 can be driven. To mount image sensor 12, using an x-y traversing table 13 having printed-circuit-board receptacles 17, image sensor 12 with protective cover 7 on printed circuit board 9 is pressed against middle spacers 4. A positioning motor 14 turns optical unit 1 into cylindrical hole 3 until the electronics via socket 11 emit a sharp image. The x-y traversing table 13 is alternatively controlled manually by operating personnel and/or automatically, until features on test pattern 15, which are located at a defined location in front of optical unit 1, move to the desired position within the image, generated by image sensor 12, in the form of image data. In an alternative variant, the process of focusing and the x-y alignment are repeated iteratively until the desired precision is achieved. During or immediately after the adjustment process described, in one variant of the preferred exemplary embodiment, further adjustment parameters of the image quality of image sensor 12 are determined. In particular, they include at least one adjustment parameter for the intrinsic calibration and/or at least one adjustment parameter of the fixed pattern noise correction. After the desired positioning is accomplished, printed circuit board 9 is pressed via a tension spring 16 against housing 2, so that the image sensor chip is no longer able to move relative to cylindrical hole 3. Alternatively or additionally, an adhesive agent and/or at least one screw-connection means are possible for fixing image sensor 12 in position relative to housing 2. In conclusion, reverse-side cover 20 is mounted, for example, by screws. This reverse-side cover 20 has the function to clamp printed circuit board 9 and/or to achieve the electromagnetic compatibility (EMC) imperviousness by grounded connection, and/or to attain a thermal junction between image sensor 12 and the surroundings for cooling image sensor 12.

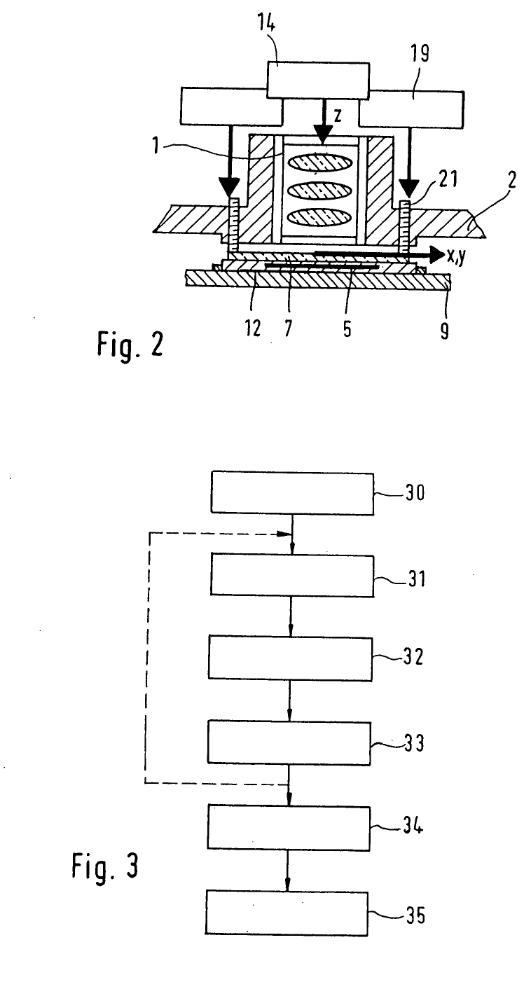

FIG. 2 shows a variant of the image recording system of the preferred exemplary embodiment, only the central part of FIG. 1 having image sensor 12 and optical unit 1 being depicted. Components already specified in FIG. 1 are no longer clarified in the following. The high dimensional accuracy of imager 5 with respect to protective cover 7 on image sensor 12 increases the costs for producing image sensor 12. Therefore, in the variant of the preferred exemplary embodiment described here, compensation is made for the wobble angle error, thus the rotation of image sensor 12 about the x axis and/or y axis, between imager 5 and protective cover 7 using a suitable adjusting mechanism. To that end, at least two of the at least three spacers used are replaced by screws 21 in this variant of the preferred exemplary embodiment. During the focusing process via positioning motor 14, at the same time at least two further screw positioning motors 19 are driven, accompanied by measurement of features distributed over the image, imager 5 in image sensor 12 being set in alignment with optical unit 1. FIG. 3 shows a flow chart of the method for producing an image recording system of the preferred exemplary embodiment, including the variants described. In first method step 30, the image sensor together with the protective cover on the printed circuit board is pressed against the spacers that are located in the region of the cylindrical hole and, in the variant described here, are implemented as screws. In second method step 31, the optical unit is screwed by a positioning motor into the cylindrical hole, until a downstream evaluation unit emits a signal that a sharp image is present. Subsequent method step 32 is used to radially align the main axis of the image sensor and the main axis of the optical unit relative to each other by bringing the image sensor to the desired x-y position via an x-y traversing table. In subsequent method step 33, the main axis of the image sensor and the main axis of the optical unit are axially aligned relative to each other by adjustment of the screws. Optionally, method steps 31, 32, 33 are repeated iteratively until the desired alignment precision is attained. In subsequent method step 34, as a function of the image data from the test pattern, at least one further adjustment parameter of the image sensor, e.g., at least one adjustment parameter for the intrinsic calibration and/or at least one adjustment parameter of the fixed pattern noise correction, is ascertained and optionally set. Last method step 36 is used to fix the image sensor in position relative to the housing using fastening means.

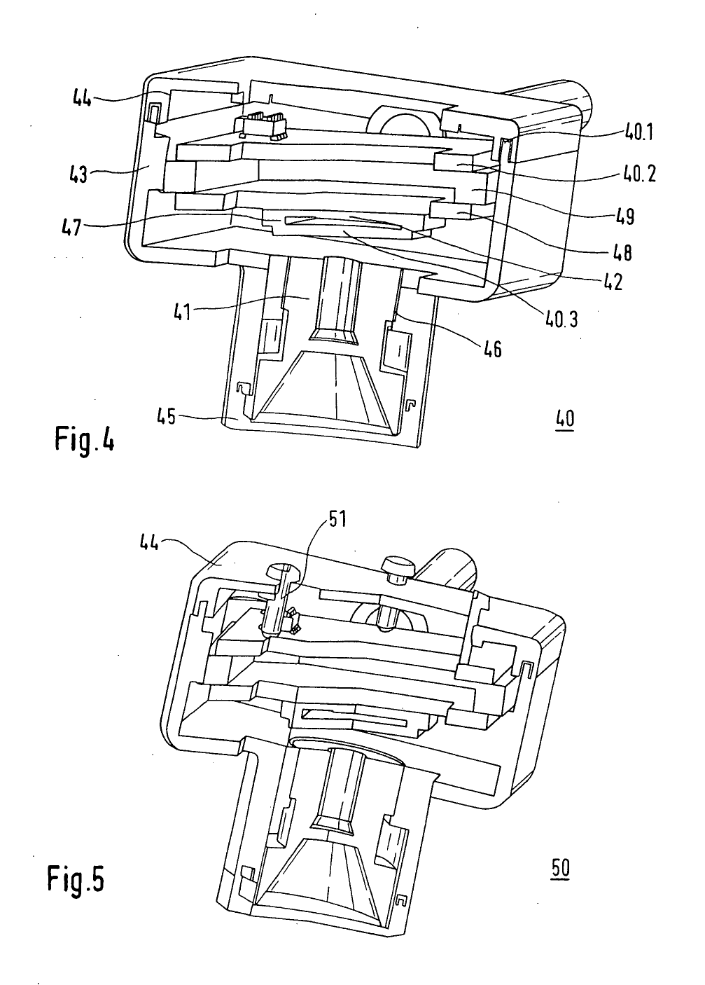

In the following, another advantageous embodiment variant of the invention is elucidated with reference to FIG. 4 and FIG. 5.

Image recording system 40 shown in FIG. 4 includes a housing 40.1, 44 made up of an essentially cup-shaped housing member 40.1 and a cover 44 sealing housing member 40.1. An optical module 41 is joined to housing member 40.1. Disposed in housing member 40.1 is an image sensor 47 that has an imager chip 42 and is in operative connection with optical module 41. In this context, operative connection means that optical module 41 images an image, corresponding to the receiving region of optical module 41, onto image sensor 47, or, more precisely, onto imager chip 42 of image sensor 47. Image sensor 47, together with imager chip 42 made of photosensitive silicon, is preferably bonded and/or soldered to a first printed circuit board 48. Printed circuit board 48 bearing image sensor 47 is arranged on a first surface of an intermediate support 49. Intermediate support 49 bears a second printed circuit board 40.2 on its second surface. Disposed on this second printed circuit board are electronic components, plug connectors and the like (not shown in the figure), which are electrically connected from the standpoint of circuit engineering to image sensor 47 situated on first printed circuit board 48. At least partial areas of the periphery of intermediate support 49 have the shape of a spherical lateral surface. The regions of the periphery of intermediate support 49 thus shaped engage with form locking in correspondingly form-matched regions 43 of the inside wall of housing member 40.1, which thus likewise represent parts of a spherical surface. Intermediate support 49 is therefore virtually supported in a kind of spherical joint. In a first embodiment variant, at least two partial areas of the periphery of the intermediate support defining the diameter of intermediate support 49 are shaped in such a way in the form of a spherical surface and engage in at least two form-matched regions 43 of the inside wall of housing member 40.1. In another embodiment variant, three such areas are provided that are expediently arranged in rotationally symmetrical fashion, and therefore are set apart from each other angle-wise by approximately 120°. In a further embodiment variant, four partial areas may be provided which are set apart from each other angle-wise by 90°. In another embodiment variant which permits particularly secure mounting of the intermediate support, the complete periphery of intermediate support 49 is circular and formed as part of a spherical lateral surface supported in a form-matched annular structure in the interior of housing member 40.1. In all the embodiment variants described above, intermediate support 49 is mounted by way of the bearing similar to a ball bearing in housing member 40.1 in a manner allowing easy rotation and tilting. In this way, by turning and/or tilting intermediate support 49, imager chip 42 can be aligned very easily and nevertheless with high precision with optical module 41. After setting the optimum alignment position, intermediate support 49 may be permanently fixed in position in its ball bearing by, for example, a quick-hardening adhesive, in order to secure the alignment position.

In the embodiment variant of an image recording system 50 shown in FIG. 5, three adjusting screws 51 are provided that are rotationally mounted in housing bottom 44. These adjusting screws 51 are preferably arranged symmetrically with respect to the optical axis of image recording system 50, and viewed angle-wise, for instance, are uniformly spaced apart on a circle in such a way that they have an angular spacing of 120°. The tips of adjusting screws 51 either engage directly with the outer surface of printed circuit board 40.2 facing them, or, in an embodiment variant, engage through openings in printed circuit board 40.2 directly with the outer surface of intermediate support 49 facing them. Therefore, these adjusting screws 51 form a three-point support adjustment for the precise adjustment of intermediate support 49 into a specific tilt position. When a tilt position of intermediate support 49 corresponding to an optimal alignment is achieved by twisting adjusting screws 51, the three adjusting screws 51 are expediently secured in their position by an adhesive.

An image recording system according to FIG. 4 is expediently produced as follows. Optical module 41, sealed frontally by a protective cover 45 transparent to radiation, is joined to housing member 40.1 of the housing with the aid of a joining means 46, in particular an adhesive. Printed circuit boards 40.2, 48, fitted with the components such as image sensor, electronic components, plug connections and the like, are joined, in particular screwed, to intermediate support 49. An adhesive, preferably able to be cured by UV radiation, is applied on regions 43 of housing member 40.1 that have the shape of a spherical lateral surface. With image sensor 47 aligned in the direction of optical module 41, the intermediate support is subsequently introduced into housing member 40.1 and supported there in the “ball bearing” formed by regions 43. Image sensor 47 is adjusted with respect to optical module 41 by turning and tilting intermediate support 49 within the ball bearing. After reaching an optimal alignment position, the adhesive is cured by irradiation with UV light. Intermediate support 49 is thereby permanently fixed in position. In conclusion, cover 44 is bonded to housing member 40.1.

The method for manufacturing an image recording system according to FIG. 5 differs from the method previously described only in that the tilt position of intermediate support 49 is precisely adjusted by adjusting screws 51.

The image recording systems described and the method for producing an image recording system are suitable for CCD image sensors and/or CMOS image sensors.

1-14. (canceled)

15. An image recording system, comprising:
at least one image sensor;
at least one optical unit;
at least one housing; and
a fastening arrangement for fixing the image sensor in position relative to the housing, wherein:
the housing includes an arrangement for accommodating the optical unit, and
the housing includes a first alignment arrangement on an inside in order to align a main axis of the image sensor and a main axis of the optical unit relative to each other.

16. The image recording system as recited in claim 15, wherein the image recording system is used in a motor vehicle.

17. The image recording system as recited in claim 15, wherein the first alignment arrangement permits an attachment-free, axial alignment of the main axis of the image sensor and the main axis of the optical unit relative to each other.

18. The image recording system as recited in claim 15, wherein the arrangement for accommodating the optical unit includes a threaded mount.

19. The image recording system as recited in claim 15, further comprising:
a second alignment arrangement; and
a printed circuit board on which the image sensor is arranged, the printed circuit board being able to be positioned by the second alignment arrangement relative to the housing.

20. The image recording system as recited in claim 19, wherein the second alignment arrangement includes at least one spacer.

21. The image recording system as recited in claim 15, wherein:
the fastening arrangement includes at least one of an adhesive agent, at least one screw-connection arrangement, and at least one clamping-connection arrangement corresponding to at least one tension spring.

22. The image recording system as recited in claim 15, wherein at least one part of the first alignment arrangement is adjustable.

23. The image recording system as recited in claim 15, wherein the first alignment arrangement includes at least three spacers for setting the image sensor apart from the housing, at least two of the at least three spacers being adjustable in a spacing direction.

24. The image recording system as recited in claim 15, further comprising:
an intermediate support supported in a ball bearing and on which the image sensor is disposed.

25. The image recording system as recited in claim 24, wherein the ball bearing is formed from edge areas of the intermediate support that in each case are in the shape of a spherical lateral surface and regions of the housing member that are in the shape of a spherical lateral surface, which intermesh with form locking in an interior of the housing.

26. The image recording system as recited in claim 24, further comprising:
adjusting screws braced on one side on the housing, and on another side, one of directly and indirectly on the intermediate support.

27. A method for producing an image recording system, comprising:
implementing an attachment-free, axial alignment of a main axis of an image sensor of the image recording system and a main axis of an optical unit of the image recording system relative to each other by an alignment arrangement mounted on an inner side of a housing of the image recording system; and
radially aligning the main axis of the image sensor and the main axis of the optical unit relative to each other as a function of image data of the image sensor in such a way that the image sensor generates image data from a test pattern located outside of the housing.

28. The method as recited in claim 27, further comprising:
after the radially aligning step, fixing the image sensor in position relative to the housing by a fastening arrangement that includes at least one of an adhesive agent, at least one screw-connection arrangement, and at least one clamping-connection arrangement including at least one tension spring.

29. The method as recited in claim 27, further comprising:
setting an image sharpness as a function of the image data from the test pattern by adjusting a position of the optical unit in the housing using an adjusting mechanism.

30. The method as recited in claim 27, further comprising:
as a function of the image data from the test pattern, ascertaining and optionally setting at least one of:
at least one adjustment parameter of the image sensor corresponding to at least one adjustment parameter for an intrinsic calibration, and
at least one adjustment parameter of a fixed pattern noise correction.
